(19) United States
(12) Patent Application Publication
(10) Pub. No.: US 2013/0280535 A1
(43) Pub. Date: Oct. 24, 2013

(54) MULTILAYER SHEET AND METHODS OF MAKING AND ARTICLES COMPRISING THE MULTILAYER SHEET

(71) Applicants: Christianus Johannes Jacobus Maas, Rilland (NL); Hans Frijters, Meerle (BE); Bernd Jansen, Bergen op Zoom (NL); Constantin Donea, Evansville, IN (US)

(72) Inventors: Christianus Johannes Jacobus Maas, Rilland (NL); Hans Frijters, Meerle (BE); Bernd Jansen, Bergen op Zoom (NL); Constantin Donea, Evansville, IN (US)

(73) Assignee: SABIC INNOVATIVE PLASTICS IP B.V., Bergen op Zoom (NL)

(21) Appl. No.: 13/453,026

(22) Filed: Apr. 23, 2012

(51) Int. Cl. B29C 51/02; B32B 27/08

(52) U.S. Cl. 428/412; 264/234

(57) ABSTRACT

In an embodiment, a method of making an article comprises: co-extruding a core layer formed from a core composition comprising a core thermoplastic polymer and a first cap layer formed from a first cap composition comprising an intumescent flame retardant material to form the article; and thermoforming the article. In an embodiment, a multilayer sheet, comprises: an extruded first cap layer formed from a first cap composition comprising an intumescent flame retardant material; and a co-extruded core layer formed from a core composition comprising a thermoplastic polymer, wherein the first cap layer is disposed upon and in intimate contact with a surface of the core layer; wherein the first cap layer and the second cap layer have an adhesion test value of greater than 2 as measured according to ASTM D3359-02 before thermoforming the first cap layer and the second cap layer.

### TECHNICAL FIELD

The present disclosure generally relates multilayered sheets, and more particularly to multilayered sheets having intumescent and flame retarding properties.

### BACKGROUND

Thermoplastic (e.g., polycarbonate) sheet material is commonly used in rail and aircraft applications, e.g., in seats or cladding applications. These applications typically require stringent fire safety requirements are met such as flame retardance, smoke density, smoke toxicity, and heat release. Thermoplastic materials such as polycarbonate have difficulty meeting heat release requirements for aircraft and rail applications and often have to be combined with other, more expensive materials, to pass the aircraft and rail application tests. Various requirements have been placed on the flame retardance, smoke density, smoke toxicity, and heat release properties of the sheet materials used in the construction of interior panels and parts for aircraft and rail applications.

For example, U.S. Pat. No. 7,695,815 describes a laminate having a top layer with at least 50 weight percent polycarbonate in combination with a polycarbonate-polysiloxane copolymer, and a polyetherimide to reduce smoke density.

In some applications, in addition to meeting flame retardance, smoke density, smoke toxicity, and heat release properties, the sheet material is also desired to be environmentally friendly. Although the sheet may meet flame retardance, smoke density, smoke toxicity, and heat release requirements for a given application, it may not meet the desired environmental requirements. Adhesion between the various layers of a multiwall sheet after thermoforming can also be an issue, with the layers de-laminating from one another following thermoforming.

Multilayer sheets that can meet or exceed the various fire safety requirements (e.g., in rail and/or aircraft applications), and/or that are made from environmentally friendly sheet materials, are desired in the industry. Additionally, multilayer sheets that meet or exceed the various fire safety requirements in transportation interior applications and that can be thermoformed without an adverse effect on adhesion or heat stability of the layers of the multilayer sheet are also desired.

### BRIEF DESCRIPTION

Disclosed herein are multilayer sheets, methods of making multilayer sheets, and articles formed from the multilayer sheets.

In an embodiment, a method of making an article comprises: co-extruding a core layer formed from a core composition comprising a core thermoplastic polymer and a first cap layer formed from a first cap composition comprising an intumescent flame retardant material to form the article; and thermoforming the article.

In an embodiment, a method of making an article comprises: co-extruding a core layer formed from a core composition comprising a core thermoplastic polymer and a first cap layer formed from a first cap composition comprising an intumescent flame retardant material to form a multilayer sheet; and thermoforming the multilayer sheet to form the article, wherein the first cap layer and the core layer have an adhesion test value of greater than 2A as measured according to ASTM D3359-02 before thermoforming to form the article; wherein, if a core layer and a cap layer formed from the same core composition and the same first cap composition are formed by another method to form another multilayer sheet, a thermoformed article of the another multilayer sheet will have an adhesion of less than 2A as measured according to ASTM D3359-02 before thermoforming to form another article.

In an embodiment, a multilayer sheet comprises: an extruded first cap layer formed from a first cap composition comprising an intumescent flame retardant material; and a co-extruded core layer formed from a core composition comprising a thermoplastic polymer, wherein the first cap layer is disposed upon and in intimate contact with a surface of the core layer; wherein the first cap layer and the second cap layer have an adhesion test value of greater than 2 as measured according to ASTM D3359-02 before thermoforming the first cap layer and the second cap layer.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a depiction of a multilayer sheet with a first cap layer disposed upon and in intimate contact with a surface of a core layer.

FIG. 2 is a depiction of a multilayer sheet with a core layer disposed between a first cap layer and a second cap layer.

FIG. 3 is a depiction of a multilayer sheet with a second cap layer disposed between a first cap layer and a core layer.

FIG. 4 is a depiction of a multilayer sheet with a first cap layer disposed between a second cap layer and a core layer.

### DETAILED DESCRIPTION

Disclosed herein are co-extruded multilayer sheets comprising a core layer and a cap layer, where the cap layer comprises an intumescent material. The co-extruded multilayer sheets can pass fire safety requirements and can be subsequently thermoformed without a loss of aesthetics, adhesion, and/or heat stability when thermoformed. Current multilayer sheets made from flame retardant polycarbonate do not meet all fire safety and smoke density requirements. For example, a flame retardant polycarbonate sheet can comprise halogen additives (e.g., a brominated polycarbonate) in order to pass flammability tests such as the Federal Aviation Regulation Part (FAR) 25.853, but the halogen causes the sheet to emit more smoke when burned. The sheets can, therefore, have issues passing some of the smoke density generation standards.

Disclosed herein are multilayer sheets (e.g., co-extruded multilayer sheets), comprising a thermoplastic material, that can be used in rail and aircraft applications, e.g., in seats and/or cladding applications and methods of making articles comprising the multilayer sheets. The multilayer sheets can meet the stringent fire safety requirements for both rail and aircraft applications. The multilayer sheets disclosed herein can pass flame retardancy, heat release, smoke density, and smoke toxicity tests so that they can be used in such applications. For example, the multilayer sheets disclosed herein can consistently (i.e., 100% of the time) pass the smoke density test as set forth in ASTM E662 (i.e., the average of three samples always possesses a smoke density at four minutes of less than 200 particles). The multilayer sheets disclosed herein utilize a multilayer construction comprising core layer(s) and cap layer(s), where the core layer comprises a thermoplastic material, and optionally, a flame retardant and the cap layer(s) comprises an intumescent material. The addition of an intumescent material in the cap layer(s) advantageously results in a multilayer sheet having improved flame retardancy, heat release, smoke density, and smoke toxicity performance as compared to a sheet without a cap layer comprising an intumescent material.

Furthermore, the addition of a co-extruded cap layer can allow the multilayer sheet to be subsequently thermoformed without a loss in properties such as heat stability (e.g., discoloring and/or cracking) and/or adhesion between the layers of the multilayer sheet. For example, articles comprising a co-extruded core layer and cap layer, where the cap layer comprises an intumescent material, can achieve an adhesion test value of greater than 2, specifically, greater than or equal to 3, more specifically, greater than or equal to 4, and even more specifically, equal to 5. The intumescent material of the first cap layer, which can also function as a flame retardant material, can optionally, additionally comprise a flame retardant material. The addition of a thin cap layer comprising an intumescent material can significantly reduce the cost of an article formed from the multilayer sheet comprising a core layer and a first cap layer.

The transportation industry (e.g., rail and aircraft) continually desires an increase in flame retardancy in the materials used in its applications. For example, a lower thickness product in these applications can be desired to reduce weight and/or cost. However, a reduction in thickness typically results in difficulty passing the flame retardancy, smoke density, smoke toxicity, and heat release tests. Additionally, as temperatures are increased, e.g., in processing or during usage, the need for high performance flame retardant materials arises and there is an increasing trend to use more environmentally friendly materials and to replace halogen flame retardants. All of these features, desired by the transportation industry, are met with the multilayer sheets disclosed herein, which comprise a co-extruded core and cap layer, where the cap layer can comprise an intumescent flame retardant material.

For example, polycarbonate materials (e.g., LEXAN*, commercially available from SABIC Innovative Plastics) can be subject to temperatures of 160° C. to 280° C. during forming, a predrying and mold temperature of 80° C. to 120° C., and a cooling time of 20 to 30 seconds. Polycarbonate/acrylonitrile butadiene styrene materials (e.g., CYCOLOY*, commercially available from SABIC Innovative Plastics) can be subject to temperatures of 180° C. to 280° C. during forming, a predrying and mold temperature of 120° C., and a cooling time of 20 seconds. Polyetherimide (e.g., ULTEM*, commercially available from SABIC Innovative Plastics) can be subject to temperatures of 230° C. to 300° C. during forming, a predrying and mold temperature of 160° C., and a cooling time of 30 seconds.

Intumescent materials generally refers to materials that begin to swell and char when exposed to flames and then rapidly react to become a compact foam that delays heat migration. Intumescent materials can generally be used to restrain, retard, or suppress burning processes to give occupants trapped inside a structure (e.g., a train, airplane, or building) an opportunity to escape by giving off less dark smoke (e.g., black smoke which decreases visibility), acid gas, and/or carbon monoxide when a fire occurs. When exposed to flames and/or high heat, and/or when a cap layer comprises an intumescent flame retardant material, the cap layer can expand and produce a char, which can insulate the surface of the core layer and aid in keeping oxygen away from the core layer, thus protecting the core layer from burning and/or damage caused by flames. For example, the cap layer can, upon exposure to heat and/or flames (e.g., 50 kilowatts per square meter (50 kW/m²)), produce a charred protective layer having a thickness of greater than or equal to 1.5 cm, specifically greater than or equal to 2 cm.

The multilayer sheets disclosed herein can be employed in a variety of aircraft and rail compartment interior applications, as well as interior applications for other modes of transportation, such as bus, train, subway, and the like. Exemplary aircraft interior components can include, without limitation, partition walls, cabinet walls, sidewall panels, ceiling panels, floor panels, equipment panels, light panels, window moldings, window slides, storage compartments, galley surfaces, equipment housings, seat housings, speaker housings, duct housing, storage housings, shelves, trays, and the like. The same applies to rail applications. It is generally noted that the overall size, shape, thickness, optical properties, and the like of the multilayer sheets disclosed herein can vary depending upon the desired application.

Rail interior applications in Europe typically require the material or articles made therefrom meet the new EN45545 standard, which requires the material or articles to pass the smoke density test according to the standard set forth by International Standards Organization (ISO) 5659-2:2003, the heat release test according to ISO5660-1, and the flame spread test set for in ISO 5658-2. For rail applications three hazard levels are present in the tests, which set forth the specification limits for the smoke density and heat release tests. For purposes of this application, the specification hazard level two was considered, which sets a limit on the smoke density (Ds @ 4 minutes) of less than 300 particles and a limit on the heat release (Maximum Average Heat Release (MAHRE) (MAHRE kilowatt (kW) @50 kW)) of less than 90 kiloWatts per square meter (kW/m²). Specific optical density (i.e., Ds) is a dimensionless measure of the amount of smoke produced per unit area by a material when it is burned. The National Bureau of Standards (NBS) Smoke Density test conducted per 14 C.F.R. 25.853 measures the maximum value of Ds that occurs during the first 4 minutes of the test.

For aircraft applications, the material or article should be able to meet the requirements set forth by the American Society for Testing and Materials (ASTM) standard E662 (2006). A composition satisfying the smoke generation requirements for aircraft compartment interiors means a composition which meets the specification limits set forth in ASTM E662 (2006). This test method uses a photometric scale to measure the density of smoke generated by the material. Multilayer sheets satisfying the smoke generation requirements for aircraft interiors have a smoke density of less than 200 particles, in accordance with ASTM E662-06. While the tests described were chosen to show the ability of the multilayer sheets described herein to satisfy both the smoke generation and flammability requirements for aircraft interiors, the sheets can advantageously comply with other related flammability and safety tests. Examples of other such tests can include, without limitation, FR-1 tests, such as NF P 92-505, the ADB0031 test set forth by the aircraft manufacturer Airbus, FAR 25.853, toxicity tests, and the heat release test OSU 65/65 promulgated by the aircraft manufacturer Boeing.

In some interior compartment applications, it can be desirable for the multilayer sheet to have certain optical properties. For example, it can be desirable to have a transparent sheet or an opaque sheet. An opaque sheet generally refers to a sheet that has less than or equal to 3% light transmission, specifically, less than or equal to 1% light transmission, more specifically, less than or equal to 0.5% light transmission, and even more specifically, less than or equal to 0.25% light transmission. With regards to the transparency or opacity of the multilayer sheet, it is briefly noted that end user specifications (e.g., commercial airline specifications or commercial rail applications) generally specify that the component satisfy a particular predetermined threshold. Haze values, as measured by ANSI/ASTM D1003-00, can be a useful determination of the optical properties of the transparent flame retardant polycarbonate sheet. The lower the haze levels, the higher the light transmission value of the finished sheet. Haze can be measured using ASTM D1003-00, procedure B, using CIE (International Commission on Illumination) standard illuminant C. Flame retardant additives, e.g. sodium p-toluene sulfonate, can have an impact on the haze of the final thermoplastic sheet. Therefore, it can be desirable to monitor the haze levels of the sheet along with flammability and smoke generation properties in order to produce an aircraft interior component that satisfies both safety and aesthetic quality specifications.

A more complete understanding of the components, processes, and apparatuses disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

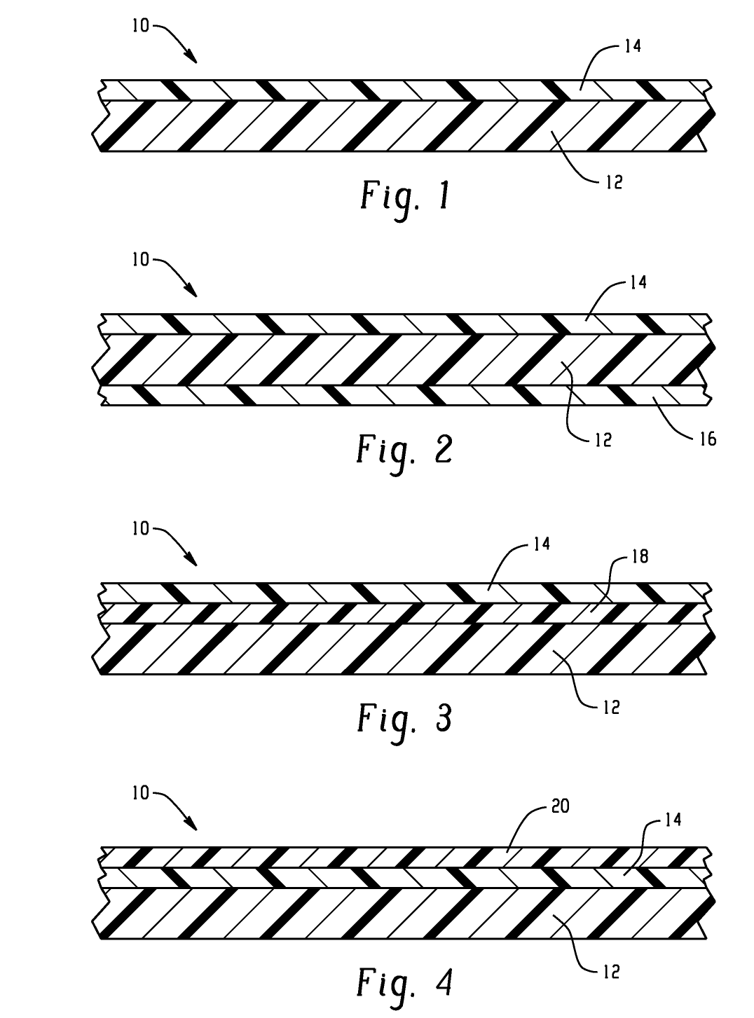

FIG. 1 illustrates a multilayer sheet 10 comprising a core layer 12 and a first cap layer 14 disposed upon and in intimate contact (e.g., physical contact) with the core layer 12. FIG. 2 illustrates another embodiment, where a multilayer sheet 10 can comprise a core layer 12 located between a first cap layer 14 and a second cap layer 16, while FIG. 3 illustrates an embodiment where a multilayer sheet 10 can comprise a second cap layer 18 disposed between a first cap layer 14 and a core layer 12. Finally, FIG. 4 illustrates a multilayer sheet 10 comprising a first cap layer 14 disposed between a second cap layer 20 and a core layer 12. In each of the embodiments illustrated in FIGS. 1 through 4, the first cap layer and/or the second cap layer can be disposed across the surface of the core layer.

The core layer 12 can comprise a core composition comprising a plastic material, such as thermoplastic resins, thermosets, and combinations comprising at least one of the foregoing. Possible thermoplastic resins that may be employed in core layer 12 include, but are not limited to, oligomers, polymers, ionomers, dendrimers, copolymers such as graft copolymers, block copolymers (e.g., star block copolymers, random copolymers, etc.) and combinations comprising at least one of the foregoing. Examples of such thermoplastic resins include, but are not limited to, polycarbonates (e.g., blends of polycarbonate (such as, polycarbonate-polybutadiene blends, copolyester polycarbonates)), polystyrenes (e.g., copolymers of polycarbonate and styrene, polyphenylene ether-polystyrene blends), polyimides (e.g., polyetherimides), acrylonitrile-styrene-butadiene (ABS), polyalkylmethacrylates (e.g., polymethylmethacrylates), polyesters (e.g., copolyesters, polythioesters), polyolefins (e.g., polypropylenes and polyethylenes, high density polyethylenes, low density polyethylenes, linear low density polyethylenes), polyamides (e.g., polyamideimides), polyarylates, polysulfones (e.g., polyarylsulfones, polysulfonamides), polyphenylene sulfides, polytetrafluoroethylenes, polyethers (e.g., polyether ketones, polyether etherketones, polyethersulfones), polyacrylics, polyacetals, polybenzoxazoles (e.g., polybenzothiazinophenothiazines, polybenzothiazoles), polyoxadiazoles, polypyrazinoquinoxalines, polypyromellitimides, polyquinoxalines, polybenzimidazoles, polyoxindoles, polyoxoisoindolines (e.g., polydioxoisoindolines), polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyls (e.g., polyvinyl ethers, polyvinyl thioethers, polyvinyl alcohols, polyvinyl ketones, polyvinyl halides, polyvinyl nitriles, polyvinyl esters, polyvinylchlorides), polysulfonates, polysulfides, polyureas, polyphosphazenes, polysilazzanes, polysiloxanes, and combinations comprising at least one of the foregoing.

More particularly, the thermoplastic material used in the core composition can include, but is not limited to, polycarbonate resins (e.g., LEXAN* resins, commercially available from SABIC Innovative Plastics), polyphenylene ether-polystyrene blends (e.g., NORYL* resins, commercially available from SABIC Innovative Plastics), polyetherimide resins (e.g., ULTEM* resins, commercially available from SABIC Innovative Plastics), polybutylene terephthalate-polycarbonate blends (e.g., XENOY* resins, commercially available from SABIC Innovative Plastics), copolyestercarbonate resins (e.g. LEXAN* SLX resins, commercially available from SABIC Innovative Plastics), acrylonitrile butadiene styrene resins (e.g., CYCOLOY* resins, commercially available from SABIC Innovative Plastics) and combinations comprising at least one of the foregoing resins. Even more particularly, the thermoplastic resins can include, but are not limited to, homopolymers and copolymers of a polycarbonate, a polyester, a polyacrylate, a polyamide, a polyetherimide, a polyphenylene ether, or a combination comprising at least one of the foregoing resins. The polycarbonate can comprise copolymers of polycarbonate (e.g., polycarbonate-polysiloxane, such as polycarbonate-polysiloxane block copolymer), linear polycarbonate, branched polycarbonate, end-capped polycarbonate (e.g., nitrile end-capped polycarbonate) blends of PC, such as PC/ABS blend, and combinations comprising at least one of the foregoing, for example a combination of branched and linear polycarbonate.

The thickness of the core layer 12 can vary depending upon the desired end use of the multilayer sheet 10. The core layer 12 can comprise a monolithic (e.g., one wall) sheet or a multiwall sheet (e.g., comprising greater than one wall with greater than one air channel located therebetween). A multiwall sheet generally comprises greater than one core layer. Generally, the thickness of the core layer 12 can be less than or equal to 55 millimeters (mm), specifically, 4 mm to 55 mm, more specifically, 2 mm to 35 mm, even more specifically, 1 mm to 25 mm, and still more specifically, 0.5 mm to 20 mm, as well as any and all ranges and endpoints located therebetween. For example, for a multiwall sheet, the thickness of all the walls (i.e., the total thickness of all the core layers) can be 4 mm to 55 mm, while for a monolithic sheet, the thickness of the core layer can be 0.5 mm to 20 mm.

The cap layer 14, 16 can comprise a cap composition comprising an intumescent material. Intumescent materials can have a charring effect when exposed to flames and/or high temperatures meaning that when the intumescent material is heated and/or exposed to flames, a cap layer 14, 16 comprising the intumescent material can form a foamed char layer protecting the underlying layer (e.g., core layer 12), thereby resulting in improved flame retardance, smoke density, smoke toxicity, and heat release properties. By using a cap layer 14, 16 comprising an intumescent material, it can be possible for the heat and/or flames from the fire to not reach the core layer 12, thus, protecting it from damage caused by the heat and/or flames. The intumescent material can provide a voluminous, insulating and protective layer through the formation of char and char foam. Formation of a protective layer isolates the fuel (e.g., core layer) from oxygen.

Intumescent materials can be formed from a combination of materials including a carbon source, an expanding agent, an acid source, and a charring agent. The carbon source can comprise a material such as pentaerythritol, glucose, starch, talc, clay, polyol (e.g., sorbitol, Charmor™ PP100 manufactured by Perstorp), thermoplastic polymers, and combinations comprising at least one of the foregoing. Examples of thermoplastic polymers that can be used for the carbon source include polycarbonate, copolymers of polycarbonate, and combinations comprising at least one of the foregoing. For example, the carbon source can be a material such as a polycarbonate/ABS copolymer or blend, a polycarbonate-siloxane copolymer, isophthalate terephthalate resorcinol polycarbonate (ITR-PC), brominated polycarbonate, polyphenylene oxide/polystyrene blends, polypropylene, and combinations comprising at least one of the foregoing.

The acid source can generally be a dehydrating agent that can promote the formation of a carbonaceous char from the carbon source. The acid source can comprise a material such as acids (e.g., phosphoric acid), ammonium polyphosphate, ammonium phosphate, diammonium phosphate, organophosphorous acids (e.g., alkyl phosphate), and combinations comprising at least one of the foregoing. The expanding agent can comprise a material that releases nitrogen or can alternatively, comprise a halogen. Expanding agent generally refers to an intumescing agent that can expand the intumescent material upon heating. For example, the expanding agent can comprise a material such as urea, melamine (e.g., melamine phosphate and/or melamine polyphosphate), polyamides, chlorinated parrafins, metal hydrates (e.g., magnesium hydroxide, aluminum hydroxide, zinc borate, etc.), magnesium calcium carbonate (CaMg₃(CO₃)₄; e.g., Huntite, commercially available from MINELCO), and combinations comprising at least one of the foregoing. The charring agent can comprise a material such as silica materials (e.g., cyclic silicone), glass fibers, talc, metal oxides, magnesium carbonate, magnesium calcium carbonate (e.g., Huntite, commercially available from MINELCO), carbon (e.g., graphite), silicon carbide, bisphenol-A diphenyl phosphate (BPADP), and combinations comprising at least one of the foregoing. Not to be limited by theory, it is believed that the char produced from the intumescent material when exposed to heat and/or flames provides a physical barrier to heat and mass transfer, which therefore interferes with the combustion process.

The intumescent material of the cap layer 14, 16, can also comprise a thermoplastic material. The cap layer composition can further comprise a cap layer composition comprising thermoplastic material in addition to the intumescent material. Exemplary thermoplastic materials for the intumescent material of the cap layer 14, 16 and/or for the cap composition include all the materials listed in reference to the core layer 12. Exemplary materials include, but are not limited to, polyetherimide (ULTEM*, commercially available from SABIC Innovative Plastics), polyetherimide/polycarbonate blends (PEI/PC), isophthalate terephthalate resorcinol (ITR)/polycarbonate-polysiloxane blends, polycarbonate-polysiloxane, tetrabromobisphenol-A (TBBPA), polycarbonate, polyetherimide/polycarbonate-ester blends (PCE), polyetherimide/polyethylene terephthalate blends, polyphenylene oxide, PEI/PPE blends, polycarbonate/ABS blends, copolymers of the above listed materials, and combinations comprising at least one of the foregoing.

The thermoplastic material used in the cap layer 14, 16 can optionally be combined with other flame retardant additives such as TBBPA, potassium diphenyl sulfone-3-sulfonate (KSS), potassium perfluorobutane sulfonate (Rimar Salt), sodium p-toluene sulfonate (NaTS), sodium trichlorobenzene sulfonate (STB); anti dripping materials such as polytetrafluoroethylene (PTFE); and charring agents such as talc, and any other additive that does not adversely affect the desired properties of the multilayer sheet, as well as combinations comprising at least one of the foregoing.

The multilayer sheet 10 can additionally, optionally, comprise an intumescent ablative coating. Ablative coating generally refers to a water release system that dilutes the flames and forms an oxygen depleted layer next to a burning surface. For example, if the expanding agent of the intumescent material comprises a water releasing additive such as magnesium hydroxide or aluminum hydroxide, water can be released in a flame, forming steam. The steam can act as a foaming gas which aids in char formation. Additionally, the released water can have a cooling effect on the flames. An ablative coating generally can comprise a resin binder (e.g., a char forming organic resin such as epoxy, phenolic, or silicon resin); a reinforcing agent (e.g., silica, carbon (e.g., graphite), or ceramic (e.g., alumina, zirconia, silicon carbide); a flame retardant additive with water release properties (e.g., an inorganic flame retardant additive); and optionally, a curing agent.

As illustrated in FIG. 3, a second cap layer 18 can be disposed between and in intimate contact (e.g., physical contact) with a surface of a core layer 12 and a first cap layer 14 (e.g., disposed across the surface of the core layer 12 and the first cap layer 14). In this embodiment, the second cap layer 18 can be used to provide increased adhesion between the first cap layer 14 and the core layer 12 (e.g., a tie layer or an interlayer). The second cap layer 18 can comprise any material that can provide additional adhesion between the various layers including, but not limited to silicon tape.

As illustrated in FIG. 4, a first cap layer 14 can be disposed between and in intimate contact with a second cap layer 20 and a core layer 12. In this embodiment, the second cap layer 20 can, optionally, provide chemical and/or abrasion resistance to the multilayer sheet. In one embodiment, the second cap layer 20 can, optionally, comprise polyvinylidene fluoride (PVDF, commercially available as Kynar® film from Arkema) for chemical and/or abrasion resistance or can also, optionally, comprise a hard coat (e.g., a silicon hard coat) to provide antigraffiti and abrasion resistance to the multilayer sheet. Additionally, if second cap layer 20 is the outermost layer of the multilayer sheet 10, the second cap layer 20 can act as an antigraffiti layer, meaning that it has less adhesion to paints, inks, etc. and an increased ability to be cleaned with more aggressive cleaners than can generally be used with the core layer material, e.g., polycarbonate.

As with the core layer 12, the thickness of the cap layer 14, 16, 18, 20 can vary depending upon the desired end use of the multilayer sheet 10. Generally, the thickness of the cap layer 14, 16, 18, 20 can be less than or equal to 1.5 mm, specifically 50 micrometers to 1.5 mm, more specifically, 100 micrometers to 1 mm, even more specifically 200 micrometers to 500 micrometers, and still more specifically greater than or equal to 250 micrometers, as well as any and all ranges and endpoints located therebetween.

The core and/or cap layers of the multilayer sheet can, optionally, include various additives ordinarily incorporated into polymer compositions of this type, with the proviso that the additive(s) are selected so as to not significantly adversely affect the desired properties of the sheet, in particular, flame retardance, smoke density, smoke toxicity, heat release, and adhesion after thermoforming. Such additives can be mixed at a suitable time during the mixing of the components for forming the compositions of the core and cap layers. Exemplary additives include impact modifiers, fillers, reinforcing agents, antioxidants, heat stabilizers, light stabilizers, ultraviolet (UV) light stabilizers, plasticizers, lubricants, mold release agents, antistatic agents, colorants (such as carbon black and organic dyes), surface effect additives, radiation stabilizers (e.g., infrared absorbing), flame retardants, and anti-drip agents. A combination of additives can be used, for example a combination of a flame retardant heat stabilizer, mold release agent, and ultraviolet light stabilizer. In general, the additives can be used in the amounts generally known to be effective. The total amount of additives (other than any impact modifier, filler, or reinforcing agents) can generally be 0.001 to 5 wt. %, based on the total weight of the composition of the particular layer.

The core layer and/or the cap layer can optionally, additionally, comprise a flame retardant. Flame retardants include organic and/or inorganic materials. Organic compounds include, for example, phosphorus, sulphonates, and/or halogenated materials (e.g., comprising bromine chlorine, and so forth, such as brominated polycarbonate). Non-brominated and non-chlorinated phosphorus-containing flame retardant additives can be preferred in certain applications for regulatory reasons, for example organic phosphates and organic compounds containing phosphorus-nitrogen bonds.

Inorganic flame retardants include, for example, C₁₋₁₆ alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate (e.g., KSS); salts such as Na₂CO₃, K₂CO₃, MgCO₃, CaCO₃, and BaCO₃, or fluoro-anion complexes such as Li₃AlF₆, BaSiF₆, KBF₄, K₃AlF₆, KAlF₄, K₂SiF₆, and/or Na₃AlF₆. When present, inorganic flame retardant salts are present in amounts of 0.01 to 1 parts by weight, more specifically 0.02 to 0.5 parts by weight, based on 100 parts by weight of the total composition of the layer of the multilayer sheet in which it is included (i.e., the core layer), excluding any filler.

Anti-drip agents can also be used in the composition forming the core or cap layers, for example a fibril forming fluoropolymer such as polytetrafluoroethylene (PTFE). The anti-drip agent can be encapsulated by a rigid copolymer, for example styrene-acrylonitrile copolymer (SAN). PTFE encapsulated in SAN is known as TSAN. An exemplary TSAN comprises 50 wt. % PTFE and 50 wt. % SAN, based on the total weight of the encapsulated fluoropolymer. The SAN can comprise, for example, 75 wt. % styrene and 25 wt. % acrylonitrile based on the total weight of the copolymer. Anti-drip agents can be used in amounts of 0.1 to 1 parts by weight, based on 100 parts by weight of the total composition of the particular layer, excluding any filler.

It is further contemplated that the multilayer sheet can comprise additional core and cap layers (e.g., greater than or equal to two core layers and/or greater than or equal to three cap layers). Additionally, the multilayer sheet can also comprise layers dispersed between the core and cap layers, for example, an interlayer or an adhesive layer, such that the core layer can then be in contact with the interlayer and the interlayer can be in contact with the cap layer, or any combination thereof. Additional layers or coatings can also be present on the surface of the cap layers (such that the cap layer is between the coating and the core layer). Such layers can include, but are not limited to, hardcoats (e.g., an abrasion resistant coating as previously described), UV resistant layers, IR absorbing layers, etc. The additional layers contemplated can be added with the proviso that they not adversely affect the desired properties of the multilayer sheet (i.e., flame retardancy (retaining at least a UL rating of V0 at a thickness of 1.0 mm), and/or smoke density (consistently passing smoke density testing)). Any feasible combination of the above described additional layers is also contemplated.

The multilayer sheet can be formed by various multilayer sheet forming techniques. Some exemplary techniques include co-extrusion (e.g., single or multi-manifold), lamination, coating (e.g., in a roll mill or a roll stack), lamination, and so forth.

The multilayer sheets and methods of making are further illustrated by the following non-limiting examples.

### EXAMPLES

### Example 1

In Example 1, various compositions were tested for dripping properties according to NF P 92-505 (1995). NF P 92-505 is a dripping test that observes the behavior of possible droplets produced by applying a radiator to a specimen of the fabric to be tested. The electric radiator (500 W) has radiation intensity on the sample (located at 30 mm from the radiator) of 3 Watts per square centimeter (W/cm²). In this test, a sample is placed on a grid under the radiator and a cotton wool pad is placed in a receptacle for catching droplets 300 mm below it to collect possible droplets. The sample position is horizontal on a grid and four samples measuring 70 mm by 70 mm with a minimum weight of 2 grams are tested. Heat is then applied from the radiator and ignition of the wool pad is recorded. The test duration is 10 minutes.

Comparative Example 1 (C1) comprised a 4 mm thick polycarbonate (PC) sheet (LEXAN* 103R, commercially available from SABIC Innovative Plastics) that did not contain a flame retardant material with a melt volume rate of 10 cubic centimeters per 10 minutes (cm³/10 min). Samples 1 through 5 comprised the same polycarbonate material as C1 (i.e., core layer), but additionally had a first cap layer that comprised an intumescent paint (Firefree 88 Intumescent Fire-Retardant Paint, commercially available from Firefree Coatings, Inc.) in various thicknesses, measured in micrometers (μm), as can be seen in Table 1. Samples 1 to 5 are indicative of the multilayer sheet structure illustrated in FIG. 1. In the Table, “Burn Start” refers to the time it takes for the Sample to begin burning, while “Drip Start” refers to the time it takes for the Sample to have a non-burning drip.

TABLE 1

| | Cap Layer | Burn | | | |
|---|---|---|---|---|---|
| Sample | Thickness | Start | Drip Start | Burning Drips | Char/foam |
| No. | (μm) | (s) | (s) | (y/n; s) | formation (y/n) |
| C1 | N/A | 122 | 196 | y, 229 | N |
| 1 | 127 | 92 | 170 | y, 345 | Y |
| 2 | 178 | 95 | 181 | N | Y |
| 3 | 254 | 126 | 285 | N | Y |
| 4 | 508 | 178 | 400 | N | Y |
| 5 | 762 | 233 | N/A | N | Y |

Samples 1 to 5 in Table 1 demonstrate that with an increasing thickness of the first cap layer comprising an intumescent material, the burn start and drip start times increased. Surprisingly it was observed that with a first cap layer thickness of 762 μm, no dripping was observed as compared to C1, which did not contain a cap layer. Additionally, it was observed that at thicknesses of 178 μm, 254 μm, 508 μm, and 762 μm, no burning drips were present. A char formation occurred for Samples 1 to 5, indicating that the intumescent material functioned properly in providing a charred protective layer to the core layer. For example, to provide the desired burning and dripping properties (e.g., no burning drips and the presences of a char/foam formation), the thickness of the first cap layer and/or the second cap layer can be greater than or equal to 150 μm, specifically, greater than or equal to 175 μm, more specifically, greater than or equal to 200 μm, even more specifically, greater than or equal to 250 μm, still more specifically, greater than or equal to 300 μm, more specifically still, greater than or equal to 500 μm, still more specifically, greater than or equal to 750 μm, and even still more specifically greater than or equal to 1,000 μm. In some embodiments, the first cap layer and/or the second cap layer can comprise a thickness of 150 μm to 1000 μm, specifically 175 μm to 800 μm, and even more specifically 200 μm to 780 μm.

The above compositions were also tested for UL94 flammability ratings at a thickness of 1.0 mm following the procedure set forth in the Underwriter's Laboratory Bulletin 94 entitled “Tests for Flammability of Plastic Materials, UL94”. According to this procedure, using the Vertical Burning Test, the materials are classified as UL94 V0, UL94 V1, or UL94 V2 on the basis of the test results obtained for five samples. The procedure and criteria for each of these flammability classifications according to UL94, are, briefly, as follows:

Procedure for Vertical Burning Test: A total of 10 specimens (2 sets of 5) are tested per thickness. Five specimens of each thickness are tested after conditioning for 48 hours at 23° C. and 50% relative humidity. The other five specimens of each thickness are tested after conditioning for seven days at 70° C. The bar is mounted with the long axis vertical for flammability testing. The specimen is supported such that its lower end is 9.5 mm above the Bunsen burner tube. A blue 19 mm high flame is applied to the center of the lower edge of the specimen for 10 seconds. The time until the flaming of the bar ceases is recorded. If burning ceases, the flame is re-applied for an additional 10 seconds. Again, the time until the flaming of the bar ceases is recorded. If the specimen drips particles, these shall be allowed to fall onto a layer of untreated surgical cotton placed 305 mm below the specimen.

Table 2 lists the criteria for flammability classifications according to UL94 for the Vertical Burning Test.

TABLE 2

| Criteria Conditions | V0 | V1 | V2 |
|---|---|---|---|
| Afterflame time for each individual specimen | ≦10 s | ≦30 s | ≦30 s |
| Total afterflame time for any condition set | ≦50 s | ≦250 s | ≦250 s |
| (5 specimens) | | | |
| Afterflame plus afterglow time for each | ≦30 s | ≦60 s | ≦60 s |
| individual specimen after the second | | | |
| flame application | | | |
| Afterflame or afterglow of any specimen up | No | No | No |
| to the holding clamp | | | |
| Cotton indicator ignited by flaming particles | No | No | Yes |
| or drops | | | |

Afterflame time in Table 2 refers to the time at which the specimen continues to burn after the flame has been removed (i.e., the time until the flaming of the specimen ceases). A Horizontal Burning Test can be also be used for samples where a rating according to the Vertical Burn Test cannot be achieved. In the Horizontal Burn Test, a rating of HB, the lowest possible flammability rating, is possible. In the Horizontal Burning Test, the material shall not have a burning rate exceeding 40 mm per minute over a 75 mm span for specimens having a thickness less than 3.0 mm or shall cease to burn before the 100 mm reference mark. Since, C1 was not able to attain a UL94 V0, V1, or V2 rating, C1 was tested using the Horizontal Burning Test as set forth in UL94. The results of these tests are set forth in Table 3.

TABLE 3

| | | | +1 (s) | +2 (s) | |
|---|---|---|---|---|---|
| | Cap Layer | Total Sheet | After | After | |
| | Thickness | Thickness | Flame | Flame | |
| Sample No. | (μm) | (mm) | Time | Time | Result |
| C1 | N/A | 1 | >10 | >10 | HB |
| 1 | 127 | 1 | 0 | 0 | V0 |
| 2 | 178 | 1 | 0 | 0 | V0 |
| 3 | 254 | 1 | 0 | 0 | V0 |
| 4 | 508 | 1 | 0 | 0 | V0 |
| 5 | 762 | 1 | 0 | 0 | V0 |

Samples 1 to 5 in Table 3 demonstrate the effect of a first cap layer comprising an intumescent material on the flame retardance properties of a multilayer sheet. Each of Samples 1 to 5 achieved a UL94 V0 rating at a thickness of 1 mm, while C1 was only able to achieve a rating of HB at the same thickness. These results indicate that the presence of a first cap layer comprising an intumescent material has an advantageous effect on the flame retardance properties of a multilayer sheet. For example, the multilayer sheet can have a UL94 V0 rating at a first and/or second cap layer thickness of greater than or equal to 125 μm, specifically, greater than or equal to 150 μm, more specifically, greater than or equal to 175 μm, even more specifically, greater than or equal to 200 μm, still more specifically, greater than or equal to 250 μm, more specifically still, greater than or equal to 300 μm, still more specifically, greater than or equal to 500 μm, even still more specifically greater than or equal to 750 μm, and still even more specifically, greater than or equal to 1000 μm. In some embodiments, the first cap layer and/or the second cap layer can comprise a thickness of 125 μm to 1000 μm, specifically 175 μm to 800 μm, and even more specifically 200 μm to 780 μm and achieve a UL94 V0 rating.

Samples C1, Comparative Sample 2 (C2), and Sample 6 were tested for smoke density properties according to ASTM E662 (2006). C2 comprised the same composition as C1 with the addition of 3% wt. % of bromine as a flame retardant. Sample 5 comprised the composition of C1 with the addition of a 254 μm thick cap layer comprising a fire free intumescent paint. The results of the smoke density tests are set forth in Table 4. For the smoke density tests, measurement was made of the attenuation of a light beam by smoke (suspended solid or liquid particles) accumulating within a closed chamber due to non-flaming pyrolytic decomposition and flaming combustion. For the test, a 3-inch by 3-inch (7.62 cm by 7.62 cm) sample was mounted within an insulated ceramic tube with an electrically heated radiant-energy source mounted therein. As previously described, to satisfy aircraft requirements, a successful smoke density test is a measurement below 200 at an exposure period of 240 seconds as measured by a photometric system.

TABLE 4

| Sample No. | Cap Layer Thickness (μm) | Ds at 240 s |
|---|---|---|
| C1 | N/A | 240 |
| C2 | N/A | 230 |
| 6 | 254 μm | 90 |

As illustrated by Table 4, only Sample 6 was able to pass the smoke density test as both C1 and C2 each had smoke densities greater than 200. Sample 6 was well below the minimum requirement to pass the smoke density test with a Ds of 90 compared to 240 for C1 and 230 for C2. These results indicate that the presence of the cap layer is effective in sufficiently reducing the smoke generation of the polycarbonate sheet to meet the smoke density test requirements.

### Example 2

In Example 2, C1 was compared to Sample 7, where Sample 7 comprised a multilayer sheet having a core layer comprising polycarbonate (LEXAN* 103R, commercially available from SABIC Innovative Plastics) with a 200 μm thick first cap layer comprising an intumescent latex paint manufactured by Contego, where the overall length of the multiplayer sheet was 4 mm Sample 7 corresponds to the multilayer sheet structure illustrated in FIG. 1. Table 5 displays the drip results according to NF P 92-505, while Table 6 shows the results of the smoke density and heat release tests. Smoke density was tested according to ASTM E0662 (2009) (for aircraft applications) and ISO5659-2:2006 (for rail applications), while heat release was tested according to ISO 5660-1 (2002) (for rail applications). ISO5659-2 and ISO5660-1 are the requirements set forth in EN45545-2, which as previously mentioned, is the new rail norm test for European applications, taking effect in 2012. Materials that satisfy the ISO5659-2 and ISO5660-1 test requirements will satisfy the rail norm EN45545-2.

The test method for ISO5659-2 involves positioning specimens horizontally underneath a conical heater. Depending on the heat flux imposed, an additional gas ignition source can be applied. An irradiance of 50 kW/m² was used. The fire effluents cumulate over a time period of 20 minutes in the chamber. Optical density is measured continuously by an optical system. Toxic effluents are analyzed by Fourier Transform Infrared Spectroscopy (FTIR) at two sampling times (i.e., 4 and 8 minutes after the test has started). For each product, 3 tests are conducted. Sample specimens measure 75 mm by 75 mm and are less than or equal to 25 mm in thickness. For the assessment, an average of three tests is taken into consideration. If the individual results vary by more than 20%, (smoke density or toxicity), from the average, then 3 additional tests are conducted. For classification, three test results that do not deviate by more than 20% are needed. Smoke density can then be calculated.

The test method for ISO 5660-1 determines the heat release rate with a cone calorimeter. Specimens with dimensions of 100 mm by 100 mm are positioned horizontally underneath a conical heater. A spark ignition source supports ignition of gases. The exhaust flow rate is adjusted to 0.024 cubic meters per second (m³/s) and data is acquired every two seconds. The test duration is 20 minutes. Three end use specimens are tested for each product. The thickness should be less than or equal to 50 mm. Specimens are conditioned to a constant mass under conditions of 23° C. and 50% relative humidity for at least 24 hours. The heat release rate is determined using the oxygen consumption technique and an averaged heat release rate (average rate of heat release emission (ARHE(t)) is then calculated as a function of test time. The assessment is based on the MARHE value, which is the maximum of ARHE(t). Irradiance levels and requirements for MAHRE depend on the hazard level for individual products. For the tests conducted in this application, Hazard Level 2 was used (HL2), which has a value of 90 as specified in Table 10.

As noted in Table 6, materials that have a smoke density (i.e., Ds) at 240 seconds of less than 300 particles according to ISO5659-2:2006 and those with a heat release value of less than 90 according to ISO5660-1 meet the requirements and pass the test to be able to be used in aircraft and rail applications.

TABLE 5

| | Cap Layer | | | Burning | Char/ |
|---|---|---|---|---|---|
| Sample | Thickness | Burn Start | Drip Start | Drips | foam |
| No. | (μm) | (s) | (s) | (y/n; s) | formation (y/n) |
| C1 | N/A | 122 | 196 | y, 229 | n |
| 7 | 200 | N/A | 300 | n | y |

TABLE 6

| | | Smoke | EN45545-2 | EN45545-2 |
|---|---|---|---|---|
| | Cap Layer | Ds @4 min | Smoke Ds | MAHRE |
| | Thickness | (ASTM | @4 min | (kW) @50 kW |
| | (mm) | E0662) | (ISO5659-2) | (ISO5660-1) |
| Spec. | | | <300 | >90 |
| Hazard | | | | |
| Level 2 | | | | |
| Sample No. | | | | |
| C1 | 3 | 236.52 | 1320 | 252 |
| 7 | 3 | 82.97 | 414 | 135 |

As is illustrated in Table 5, Sample 7, containing a cap layer comprising an intumescent material, possessed superior dripping properties as compared to C1, which did not contain a cap layer. Sample 7 demonstrated no flame at the burn start, a drip start at 300 seconds, no burning drips, and a char/foam formation. The char/foam formation indicates that the cap layer comprising an intumescent material functioned as intended in providing a protective layer to the core layer. Table 6 demonstrates that Sample 7 had a significantly lower smoke density and heat release properties as compared to C1 (i.e. a 50% reduction in heat release and smoke density), which did not have a cap layer. For example, Sample 7 demonstrated a Ds at four minutes according to ASTM E0662 of 82.97, while C1 was above the limit of 200 at 236.52. Sample 7 also had a much lower smoke density according to ISO5659-2 with a Ds at four minutes of only 414 compared to C1 which was more than triple Sample 7 at 1,320.

### Example 3

In Example 3, C1 was compared to Sample 8, a multilayer sheet having a 250-300 micrometer thick cap layer comprising an ablative coating, commercially available from Hensel GmbH (HENSOTHERM 3KS) and a core layer comprising polycarbonate (LEXAN* 103R, commercially available from SABIC Innovative Plastics) where the overall length of the multilayer sheet was 4 mm Sample 8 corresponds to the multilayer sheet structure set forth in FIG. 1. The samples were tested for dripping properties according to NF P 92-505 and the results are set forth in Table 7.

TABLE 7

| | Cap Layer | | | Burning | Char/ |
|---|---|---|---|---|---|
| Sample | Thickness | Burn Start | Drip Start | Drips | foam |
| No. | (μm) | (s) | (s) | (y/n; s) | formation (y/n) |
| C1 | N/A | 122 | 196 | y, 229 | n |
| 8 | 300 | 350 | 421 | n | y |

Sample 8 further demonstrates that the use of a cap layer comprising an intumescent material provides superior dripping properties as compared to C1, which did not contain the cap layer. Sample 8 also demonstrated a char/foam formation to protect the core layer comprising polycarbonate from damage and demonstrated no burning drips. Additionally, the burn start and drip start times in Sample 8 were more than twice that of C1, indicating the usefulness of the cap layer comprising an intumescent material; here, an ablative coating.

### Example 4

In this example, C1 was compared to Sample 9, a multilayer sheet comprising a polycarbonate core layer (LEXAN* 103R, commercially available from SABIC Innovative Plastics) and a 500 micrometer cap layer where the overall length of the multilayer sheet was 4 mm. The multilayer sheet had a design as illustrated in FIG. 1. The cap layer comprised 62.14 wt. % branched polycarbonate (LEXAN* PC195, commercially available from SABIC Innovative Plastics), 20 wt. % magnesium calcium carbonate (Huntite, commercially available from MINELCO), 10 wt. % fine talc, 4 wt. % BPADP, 0.5 wt. % PTFE (Dyneon MM5935EF), 2.4 wt. % bulk ABS, 0.1 wt. % heat stabilizer (Irgaphos 168 from Chemtura), 0.1 wt. % color stabilizer (Irganox 1076 from Chemtura), and 0.76 wt. % phosphorous acid (H₃PO₃). C1 and Sample 9 were tested for drip properties according to NF P 92-505 and the results are displayed in Table 8.

TABLE 8

| | Cap Layer | | | Burning | Char/ |
|---|---|---|---|---|---|
| Sample | Thickness | Burn Start | Drip Start | Drips | foam |
| No. | (μm) | (s) | (s) | (y/n; s) | formation (y/n) |
| C1 | N/A | 122 | 196 | y, 229 | N |
| 9 | 500 | 92 | N/A | n | Y |

Although Sample 9 demonstrated a shorter burn start time than C1, no burning drips were present and there was formation of a char/foam layer in Sample 9. As with the other examples, Sample 9 demonstrates that the presence of a cap layer in the form of a char/foam layer protects the core layer from damage.

### Example 5

In this example, Comparative Sample 3 (C3) was a 3 mm thick sheet comprising a flame retardant polycarbonate (LEXAN* F6000, commercially available from SABIC Innovative Plastics). Comparative Sample 4 (C4) was a 3 mm thick sheet comprising a blend of 75 wt. % polyetherimide (PEI) and 25 wt. % polycarbonate (ULTEM* 1668, commercially available from SABIC Innovative Plastics), while Comparative Sample 5 (C5) was a 3 mm thick sheet comprising 100 wt. % polycarbonate (LEXAN* 103R). Samples 10, 11, and 12 were multilayer sheets where the core layer comprised a 3 mm thick sheet comprising the same flame retardant polycarbonate as C3. The multilayer sheet of Samples 10, 11, and 12 additionally contained a first cap layer comprising a blend of 75 wt. % polyetherimide and 25 wt. % polycarbonate (ULTEM* 1668, commercially available from SABIC Innovative Plastics) and a 50 mm thick second cap layer comprising silicon tape to provide adhesion to the multilayer sheet. The first cap layer was present in various thicknesses ranging from 125 micrometers to 300 micrometers. Samples 10, 11, and 12 correspond to the multilayer sheet structure illustrated by FIG. 3. Samples 13 and 14 were multilayer sheets comprising the same core layer as C3. In Sample 13, a 250 micrometer thick cap layer was present with the configuration illustrated in FIG. 1 that comprised ITR/polycarbonate/siloxane/brominated polycarbonate (Br—PC), while in Sample 14, first and second cap layers, each 380 micrometers thick, were present with the configuration illustrated in FIG. 3. The first and second cap layers in Sample 14 were heat laminated on both sides of the core layer. Table 9 illustrates the formulations for the samples in Example 5, while Table 10 illustrates the results obtained from the smoke density (for aircraft and rail applications) and heat release (for rail applications) tests conducted.

TABLE 9

| | | | Second Cap |
|---|---|---|---|
| | | | Layer |
| | | | Composition |
| Sam- | Core Layer | First Cap | and |
| ple | Composition and | Layer Composition | Thickness |
| No. | Thickness (mm) | and Thickness (μm) | (μm) |
| C3 | PC (LEXAN* F6000), 3 | N/A | N/A |
| C4 | 75 wt. % PEI, 25 wt. % | N/A | N/A |
| | PC (ULTEM* 1668), 3 | | |
| C5 | PC, 3 (LEXAN* | N/A | N/A |
| | 103R) | | |
| 10 | PC (LEXAN* F6000), 3 | 75 wt. % PEI, 25 wt. % | Silicon tape |
| | | PC (ULTEM*1668), 125 | |
| 11 | PC (LEXAN* F6000), 3 | 75 wt. % PEI, 25 wt. % | Silicon tape |
| | | PC (ULTEM* 1668), | |
| | | 250 | |
| 12 | PC (LEXAN* F6000), 3 | 75 wt. % PEI, 25 wt. % | Silicon tape |
| | | PC (ULTEM* 1668), | |
| | | 300 | |
| 13 | PC (LEXAN* F6000), 3 | ITR/PC/siloxane/Br-PC | Silicon tape |
| | | (LEXAN* SD9705), 250 | |
| 14 | PC (LEXAN* F6000), 3 | ITR/PC/siloxane/Br-PC | Silicon tape |
| | | (LEXAN* SD9705), 380 | |

TABLE 10

| | | Smoke | EN45545-2 | EN45545-2 |
|---|---|---|---|---|
| | Cap Layer | Ds @4 min | Smoke Ds | MAHRE (kW) |
| | Thickness | (ASTM | @4 min | @50 kW |
| | (μm) | E0662) | (ISO5659-2) | (ISO5660-1) |
| Spec. Hazard | | <200 | <300 | >90 |
| Level 2 | | | | |
| Sample No. | | | | |
| C3 | N/A | 121 | 742 | 228 |
| C4 | N/A | 28 | 134 | 70 |
| C5 | N/A | 236 | 1320 | 252 |
| 10 | 125 | 128 | 323 | 116 |
| 11 | 250 | | 150 | 97 |
| 12 | 300 | 76 | 148 | 90 |
| 13 | 250 | | 259 | 125 |
| 14 | 380 | | 215 | 110 |

The results in Table 10 demonstrate a significant improvement in both heat release and smoke density properties measured according to the new Rail norm EN45545-2 (smoke density test for aircraft according to ISO5659-2 and heat release test for rail according to ISO5660-1) with a cap layer comprising a PEI/PC blend or an ITR/PC blend applied to a core layer. Samples 10, 11, and 12 demonstrate a downward trend for smoke density and heat release properties at an increased thickness of the PEI/PC cap layer. Sample 12 was even capable of meeting the requirements of all three tests, aircraft smoke density (ASTM E0662), rail smoke density (ISO5659-2), and rail heat release (ISO5660-1). The PEI/PC blend in the cap layer in Samples 10, 11, and 12 provides an intumescent effect at a thickness of 300 micrometers to pass all three tests as described above. For example, the thickness of the cap layer can be greater than or equal to 250 μm, specifically, greater than or equal to 300 μm, more specifically, greater than or equal to 350 μm, and even more specifically, greater than or equal to 375 μm to provide the desired smoke density properties to pass the smoke density tests according to ASTME0662 and ISO5659-2. In some embodiments, the thickness of the cap layer can be greater than or equal to 300 μm and provide the desired smoke density properties according to ASTM E0662 (i.e., less than or equal to 200 particles at 4 minutes), ISO5659-2 (i.e., less than or equal to 300 particles at 4 minutes), and ISO5660-1 (i.e., heat release less than or equal to 90 kW).

### Example 6

In Example 6, different thickness cap layers were tested versus samples not containing a cap layer for heat release properties for aircraft applications according to the Ohio State University (OSU) heat release rate test, which is a modified version of ASTM E906 (2010). The test is intended for use in determining heat release rates to show compliance with the requirements of FAR 25.853. Heat release rate is measured for the duration of the test from the moment the specimen is injected into the controlled exposure chamber and encompasses the period of ignition and progressive flame involvement of the surface. Heat release is a measure of the amount of heat energy evolved by a material when burned. It is expressed in terms of energy per unit area (kilowatt minutes per square meter (kW·min/m²)). Heat release rate is a measure of the rate at which heat energy is evolved by a material when burned. It is expressed in terms of power per unit area (kilowatts per square meter (kW/m²)). The maximum heat release rate occurs when the material is burning most intensely. Heat flux density is the intensity of the thermal environment to which a sample is exposed when burned. In this test, the heat flux density used was 3.5 Watts per square centimeter (W/cm²). The size for specimens is 150 mm by 150 mm in lateral dimensions. Thickness is listed in Table 11. The specimens were conditioned at 21° C.±3° C. and 50%±5% relative humidity for a minimum of 24 hours before the test. The test period is 5 minutes and the total heat released during the first 2 minutes of the test is recorded. Three samples are tested and the average calculated and recorded. In order to pass the test, the average maximum heat release rate during the 5 minute tests cannot exceed 65 kW/m² and the average total heat released during the first 2 minutes cannot exceed 65 kW·min/m².

The formulations for each sample are listed in Table 11, while Table 12 displays the results from the tests conducted. The core layer in each sample comprised a flame retardant polycarbonate (LEXAN* F6000, commercially available from SABIC Innovative Plastics). The cap layers, when present, comprised a blend of ITR/PC/siloxane/Br—PC (LEXAN* SD9705, commercially available from SABIC Innovative Plastics). It is noted that first and second cap layer as referred to in this example are referring to cap layers on one or both sides of the core layer as illustrated in FIGS. 1 and 2 (e.g., front and back, top and bottom, etc.). Thus, the indication of a second cap layer without the presence of a first cap layer refers to the second cap layer being located on an opposite side of the core layer. For example, the first cap layer is referring to the presence of a cap layer, for example, on side A of the core layer, while the second cap layer is referring to the presence of a cap layer, for example, on side B of the core layer. Samples 15, 18, and 21 each contained a first and second cap layer, while Samples 16 and 20 each contained a first cap layer and Samples 17 and 19 each contain a second cap layer. The cap layer(s) were co-extruded to the core layer.

TABLE 11

| | Total sheet | | Second |
|---|---|---|---|
| | thickness Core Layer | First Cap Layer | Cap Layer |
| Sample No. | Thickness (mm) | Thickness (μm) | Thickness (μm) |
| C6 | 3 | N/A | N/A |
| 15 | 3 | 250 | 250 |
| 16 | 3 | 380 | N/A |
| 17 | 3 | N/A | 380 |
| 18 | 3 | 380 | 380 |
| 19 | 3 | N/A | 500 |
| 20 | 3 | 500 | N/A |
| 21 | 3 | 500 | 500 |

TABLE 12

| | Heat Release (OSU | Heat Release Rate | |
|---|---|---|---|
| | Total) | (OSU Peak) | Peak Time |
| Sample No. | (kW-min/m²) | (kW/m²) | (s) |
| C6 | 143 | 150 | 101 |
| | 151 | 152 | 105 |
| | 121 | 133 | 104 |
| Average | 138 | 145 | 103 |
| 15 | 69 | 85 | 113 |
| | 76 | 109 | 121 |
| | 81 | 104 | 118 |
| Average | 75 | 99 | 117 |
| 16 | 58 | 119 | 205 |
| | 53 | 111 | 150 |
| | 42 | 98 | 218 |
| Average | 51 | 109 | 191 |
| 17 | 166 | 159 | 85 |
| | 159 | 163 | 88 |
| | 153 | 151 | 75 |
| Average | 159 | 158 | 83 |
| 18 | 76 | 114 | 155 |
| | 47 | 120 | 266 |
| | 24 | 63 | 285 |
| Average | 49 | 59 | 235 |
| 19 | 145 | 147 | 88 |
| | 143 | 142 | 83 |
| | 135 | 137 | 89 |
| Average | 141 | 142 | 87 |
| 20 | 70 | 106 | 164 |
| | 78 | 94 | 119 |
| | 55 | 85 | 220 |
| Average | 68 | 95 | 168 |
| 21 | 88 | 86 | 119 |
| | 29 | 73 | 259 |
| | 39 | 66 | 183 |
| Average | 52 | 75 | 187 |

As can be seen from Table 12, the presence of a first cap layer (e.g., located on the top side or front side of the core layer) provides a significant improvement in the OSU total and OSU peak heat release properties. The presence of a first cap layer and a second cap layer provides an even greater improvement in the OSU total and OSU peak heat release properties for this test. Sample 18 demonstrated with a co-extruded first and a co-extruded second cap layer, each having a thickness of 380 micrometers, the OSU heat release test rate requirements can be satisfied. Examples 15 to 21 show an overall general improvement in OSU heat release properties when a cap layer was present.

### Example 7

In this example, multilayer co-extruded samples having a cap layer and samples without a cap layer were tested for smoke density, fire spread, and heat release properties. Comparative Samples 7, 8, and 9 (C7, C8, and C9, respectively) did not have a cap layer, while Samples 22 through 28 each comprised a cap layer of varying thickness and composition. The core layer in Comparative Sample 7 and Samples 22 through 24 comprised a talc filled polycarbonate/acrylonitrile butadiene styrene, while the cap layer, present in Samples 22, 23, and 24, comprised 75 wt. % polyetherimide and 25 wt. % polycarbonate (e.g., ULTEM*, commercially available from SABIC Innovative Plastics). Comparative Sample 8 as well as Samples 25 and 26 each comprised a core layer comprising flame retardant polycarbonate, while Samples 25 and 26 also comprised a cap layer comprising 75 wt. % polyetherimide and 25 wt. % polycarbonate (e.g., ULTEM*, commercially available from SABIC Innovative Plastics). Comparative Sample 9 and Samples 27 and 28 each comprised a core layer comprising flame retardant polycarbonate, while Samples 27 and 28 also comprised a cap layer comprising ITR/polycarbonate/siloxane/brominated polycarbonate (Br—PC). The thickness of the core layer was 3 mm for all samples, while the thickness of the cap layer varied between samples as demonstrated in Table 13. In Samples 22 to 28, the core layer was co-extruded with the cap layer to produce multilayer co-extruded samples. Sample 22 to 28 had the multilayer design illustrated in FIG. 1.

Smoke density and heat release were measured as previously described. Fire spread was measured according to ISO 5658-2 (2006). In this test, lateral flame spread is determined on vertically oriented specimens using a rectangular radiant panel and an additional gas burner flame as the ignition sources. The assessment is based on the Critical Heat Flux at extinguishment (CFE) value measured in kW/m2. The CFE value is the incident heat flux at the specimen surface at the point along its horizontal centerline where the flame ceases to advance and may subsequently go out. The CFE value is determined by measuring the maximum spread of flame (in mm) and relating this value to the corresponding heat flux value from the heat flux profile curve which is based on measurements with a noncombustible calibration board. Three specimens are tested for each potentially exposed surface and orientation. Specimen dimensions are 800 mm by 155 mm by less than or equal to 70 mm Two sets of three specimens are provided for the test with the average of the CFE values being used for compliance. The specimens are conditioned until a constant mass is achieved, at least 24 hours at 23° C. and 50% relative humidity. The test is terminated if there is no ignition within the first 10 minutes; flames extinguish and there is no secondary ignition in the following 10 minutes; 30 minutes after the beginning of the test no further flame spread is observed (the specimen may however still burn); and/or flames have reached the end of the specimen.

TABLE 13

| Sample | Core Layer Composition | First Cap Layer Composition and |
|---|---|---|
| No. | and Thickness (mm) | Thickness (μm) |
| C7 | Talc filled PC/ABS, 3 | N/A |
| 22 | Talc filled PC/ABS, 3 | 75 wt. % PEI, 25 wt. % PC, 185 |
| 23 | Talc filled PC/ABS, 3 | 75 wt. % PEI, 25 wt. % PC, 250 |
| 24 | Talc filled PC/ABS, 3 | 75 wt. % PEI, 25 wt. % PC, 350 |
| C8 | PC (LEXAN* F6000), 3 | N/A |
| 25 | PC (LEXAN* F6000), 3 | 75 wt. % PEI, 25 wt. % PC, 125 |
| 26 | PC (LEXAN* F6000), 3 | 75 wt. % PEI, 25 wt. % PC, 300 |
| C9 | PC (LEXAN* F6000), 3 | N/A |
| 27 | PC (LEXAN* F6000), 3 | ITR/PC/siloxane/Br-PC (LEXAN* |
| | | SD9705), 250 |
| 28 | PC (LEXAN* F6000), 3 | ITR/PC/siloxane/Br-PC (LEXAN* |
| | | SD9705), 380 |

TABLE 14

| | | | EN45545-2 | EN45545-2 |
|---|---|---|---|---|
| | Cap Layer | | Smoke Ds | MAHRE (kW) |
| | Thickness | Fire Spread | @4 min | @50 kW |
| | (μm) | (ISO5658-2) | (ISO5659-2) | (ISO5660-1) |
| Spec. Hazard | | >20 | <300 | <90 |
| Level 2 | | | | |
| Sample No. | | | | |
| C7 | 0 | 17.3 | 208 | 76 |
| 22 | 180 | 18.0 | 171 | |
| 23 | 250 | 18.7 | 122 | 36 |
| 24 | 350 | 20.0 | 106 | 37 |
| C8 | 0 | 13.8 | 742 | 228 |
| 25 | 125 | 15.8 | 323 | 116 |
| 26 | 300 | 18.5 | 148 | 104 |
| C9 | 0 | 13.8 | 742 | 228 |
| 27 | 250 | | 461 | 138 |
| 28 | 380 | | 215 | 110 |

As can be seen in Table 14, the samples comprising a cap layer produced multilayer articles that can satisfy the smoke density and heat release requirements. Each of the samples comprising co-extruded core and cap layers had a marked improvement over samples that did not comprise the cap layer (i.e., Comparatives Samples 7, 8, and 9). For example, Samples 22, 23, and 24, comprising a polyetherimide/polycarbonate cap layer, had an 18%, 41%, and 49% improvement in smoke density, respectively over C7, which did not comprise a cap layer. Samples 23 and 24 had a 7.5% and 12.6% improvement in fire spread over C7, respectively and a 53% and 51% improvement in heat release over C7, respectively. Samples 25 and 26, which comprised a polyetherimide/polycarbonate cap layer, had a 56% and 80% improvement in smoke density over C8, respectively, which did not have a cap layer. Sample 26 had a 25% improvement in fire spread over C8 and Samples 25 and 26 had a 49% and a 54% improvement in heat release compared to C8, respectively. Samples 27 and 28 also had improved properties as compared to C9, where Samples 27 and 28 each comprised a cap layer comprising ITR/siloxane copolymer with 12% brominated polycarbonate. As can be seen in Table 14, Samples 27 and 28 had a 38% and 71% improvement in smoke density compared to C9, respectively and also had a 39% and a 52% improvement in heat release compared to C9, respectively. These samples demonstrate that with the addition of a co-extruded cap layer, improved physical properties can be achieved.

Table 16 displays the results obtained from adhesion testing of samples that were co-extruded and samples that contained a coating of intumescent material before thermoforming. The samples were tested according to ASTM D3359-02, which measures whether the adhesion of a coating to a substrate is at a generally adequate level. Test Method A was used, where an X-cut is made through the film to the substrate, pressure-sensitive tap applied over the cut and then removed, and adhesion assessed qualitatively on a 0 to 5 scale, with 0 being the lowest adhesion value and 5 being the highest adhesion value. The possible ratings are displayed in Table 15. Samples 22, 24, 25, and 26 as described in Table 13 were tested and compared to Comparative Samples C10 and C 11. C10 comprised a core layer comprising talc filled flame retardant polycarbonate/ABS with a spray coated intumescent coating comprising an intumescent paint (Firefree 88 Intumescent Fire-Retardant Paint, commercially available from Firefree Coatings, Inc.). Polyvinyl alcohol functioned as the binder, ammonium phosphate as the acid source, triaminotriazine as the expanding agent, and pentaerithritol as the carbon source. The core layer had a thickness of 3 mm and the intumescent coating had a thickness of 250 micrometers. C11 comprised a core layer comprising talc filled flame retardant polycarbonate/ABS with a spray coated ablative coating comprising a resin binder, a reinforcing agent, and an inorganic flame retardant additive. The resin binder was epoxy resin, the reinforcing agents were silica and ceramic, and the inorganic flame retardant was aluminum hydroxide. The core layer had a thickness of 3 mm and the intumescent coating had a thickness of 250 micrometers.

TABLE 15
Cross-hatch adhesion ratings

| Rating | Description |
|---|---|
| 5A | No peeling or removal |
| 4A | Trace peeling or removal along incisions at their intersection |
| 3A | Jagged removal along incisions up to 1.6 mm on either side |
| 2A | Jagged removal along most incisions up to 3.2 mm |
| 1A | Removal from most of the area of the X under the tape |
| 0A | Removal beyond the area of the X |

TABLE 16
Cross-hatch test results

| | | Adhesion after |
|---|---|---|
| Sample No. | ASTM D3359 rating | thermoforming |
| C10 | 2A | Bad |
| C11 | 0A | Bad |
| 22 | 5A | Good |
| 24 | 5A | Good |
| 25 | 5A | Good |
| 26 | 5A | Good |

As demonstrated in Table 16, Samples 22, 24, 25, and 26, all of which comprised a co-extruded core and cap layer where the cap layer comprised an intumescent material, were able to achieve much higher adhesion values as compared to C10, which had an intumescent coating that was spray coated to a core layer and C11, which had an ablative coating that was spray coated to a core layer. For example, articles comprising a co-extruded core layer and cap layer, where the cap layer comprises an intumescent material, can achieve an adhesion test value of greater than 2, specifically, greater than or equal to 3, more specifically, greater than or equal 4, and even more specifically, equal to 5 before thermoforming. Adhesion after thermoforming was measured visually. A “bad” rating after thermoforming generally describes samples in which cracks and/or discoloration after thermoforming were present and visually discernible to the unaided eye, while a “good” rating after thermoforming generally describes samples that did not suffer cracking or discoloration after thermoforming that were visually discernible to the unaided eye.

It was unexpectedly discovered that when the core layer and the cap layer were co-extruded, the multilayer sheets formed therefrom could subsequently be thermoformed without a loss of aesthetics (e.g., desired physical appearance), adhesion properties, or heat stability, which can lead to discoloration and cracking during thermoforming. In applications where the core layer and cap layer were not co-extruded (e.g., where the cap layer was a coating laminated to the core layer), it was not possible to subsequently thermoform the sheets without a loss of aesthetics, adhesion between the layers, and/or heat stability. Thermoformability can be advantageous for transportation applications such as rail and aircraft applications.

The multilayer sheets disclosed herein can comprise a co-extruded core layer and cap layer, where the cap layer comprises an intumescent flame retardant material. The presence of the disclosed co-extruded cap layer can enable the multilayer sheet to pass stringent aircraft and rail requirements for use in air and rail applications, such as seats and cladding. Advantageously, it was discovered that the co-extrusion of a cap layer with a core layer provides superior dripping, smoke density, smoke toxicity, and heat release properties compared to a single layer sheet and also advantageously has the ability to be subsequently thermoformed without a loss in adhesion or heat stability properties, among others. The unique combination of a co-extruded core layer and cap layer where the cap layer comprises an intumescent flame retardant material produces a multilayer sheet capable of meeting stringent fire safety guidelines, while also being able to satisfy smoke density, smoke toxicity, and heat release requirements for use in aircraft and rail applications. Additionally, the addition of a thin cap layer can reduce the overall cost of the multilayer sheet by providing protection to the core layer.

In an embodiment, a method of making an article comprises: co-extruding a core layer formed from a core composition comprising a core thermoplastic polymer and a first cap layer formed from a first cap composition comprising an intumescent flame retardant material to form the article; and thermoforming the article.

In an embodiment, a method of making an article comprises: co-extruding a core layer formed from a core composition comprising a core thermoplastic polymer and a first cap layer formed from a first cap composition comprising an intumescent flame retardant material to form a multilayer sheet; and thermoforming the multilayer sheet to form the article, wherein the first cap layer and the core layer have an adhesion test value of greater than 2A as measured according to ASTM D3359-02 before thermoforming to form the article; wherein, if a core layer and a cap layer formed from the same core composition and the same first cap composition are formed by another method to form another multilayer sheet, a thermoformed article of the another multilayer sheet will have an adhesion of less than 2A as measured according to ASTM D3359-02 before thermoforming to form another article.

In an embodiment, a multilayer sheet comprises: an extruded first cap layer formed from a first cap composition comprising an intumescent flame retardant material; and a co-extruded core layer formed from a core composition comprising a thermoplastic polymer, wherein the first cap layer is disposed upon and in intimate contact with a surface of the core layer; wherein the first cap layer and the second cap layer have an adhesion test value of greater than 2 as measured according to ASTM D3359-02 before thermoforming the first cap layer and the second cap layer.

In the various embodiments, (i) the intumescent material of the first cap composition comprises a material selected from a charring agent, a carbon source, an acid source, an expanding source, and combinations comprising at least one of the foregoing; and/or (ii) the carbon source comprises a material selected from pentaerythritol, glucose, starch, talc, clay, polyol, thermoplastic polymers, and combinations comprising at least one of the foregoing; and/or (iii) the expanding source comprises a material selected from the group consisting of urea, melamine, polyamides, ammonium polyphosphate, chlorinated parrafins, magnesium calcium carbonate, metal hydrates, and combinations comprising at least one of the foregoing; and/or (iv) the expanding source comprises a material selected from melamine polyphosphate, magnesium hydroxide, aluminum hydroxide, zinc borate, magnesium calcium carbonate, and combinations comprising at least one of the foregoing; and/or (v) the acid source comprises a material selected from phosphoric acid, ammonium salts, amine phosphates, organophosphorous acid, and combinations comprising at least one of the foregoing; and/or (vi) the charring agent comprises a material selected from silica, glass fibers, metal oxides, carbonate materials, carbon, silicon carbide, phosphate additives, octaphenylcyclotetrasiloxane, silicon oil, bisphenol-A diphenyl phosphate, and combinations comprising at least one of the foregoing; and/or (vii) the intumescent material of the first cap composition further comprises a first cap thermoplastic polymer; and/or (viii) the core thermoplastic polymer further comprises a flame retardant material; and/or (ix) the first cap layer, upon heating and/or exposure to flames, forms a protective layer of greater than or equal to 1.5 centimeters; and/or (x) the first cap layer comprises a thickness of 50 micrometers to 1.5 millimeters; and/or (xi) the core layer comprises a thickness of 4 millimeters to 55 millimeters; and/or (xii) the core layer comprises a thickness of 0.5 millimeters to 20 millimeters; and/or (xiii) the multilayer sheet further comprises an ablative coating layer; and/or (xiv) the core layer composition comprises polycarbonate; and/or (xv) the first cap layer composition comprises a material selected from polyetherimide, polycarbonate, polysiloxane, polycarbonate-ester, polyethylene terephthalate, polyphenylene oxide, tetrabromobisphenol-A, and combinations comprising at least one of the foregoing; and/or (xvi) the first cap layer composition further comprises a flame retardant material selected from tetrabromobisphenol-A, potassium diphenyl sulfone-3-sulfonate, potassium perfluorobutane sulfonate, sodium p-toluene sulfonate, sodium trichlorobenzene sulfonate, and combinations comprising at least one of the foregoing; and/or (xvii) the multilayer sheet further comprises a second cap layer, wherein the core layer is disposed between the first cap layer and the second cap layer or wherein the second cap layer is disposed between the first cap layer and the core layer; and/or (xviii) an article comprising the multilayer sheet is thermoformed.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A method of making an article, comprising:
co-extruding a core layer formed form a core composition comprising a core thermoplastic polymer and a first cap layer formed from a first cap composition comprising an intumescent flame retardant material to form the article; and
thermoforming the article.

2. The method of claim 1, wherein the intumescent material of the first cap composition comprises a material selected from a charring agent, a carbon source, an acid source, an expanding source, and combinations comprising at least one of the foregoing.

3. The method of claim 2, wherein the carbon source comprises a material selected from pentaerythritol, glucose, starch, talc, clay, polyol, thermoplastic polymers, and combinations comprising at least one of the foregoing.

4. The method of claim 2, wherein the expanding source comprises a material selected from the group consisting of urea, melamine, polyamides, ammonium polyphosphate, chlorinated parrafins, magnesium calcium carbonate, metal hydrates, and combinations comprising at least one of the foregoing.

5. The method of claim 4, wherein the expanding source comprises a material selected from melamine polyphosphate, magnesium hydroxide, aluminum hydroxide, zinc borate, magnesium calcium carbonate, and combinations comprising at least one of the foregoing.

6. The method of claim 2, wherein the acid source comprises a material selected from phosphoric acid, ammonium salts, amine phosphates, organophosphorous acid, and combinations comprising at least one of the foregoing.

7. The method of claim 2, wherein the charring agent comprises a material selected from silica, glass fibers, metal oxides, carbonate materials, carbon, silicon carbide, phosphate additives, octaphenylcyclotetrasiloxane, silicon oil, bisphenol-A diphenyl phosphate, and combinations comprising at least one of the foregoing.

8. The method of claim 1, wherein the intumescent material of the first cap composition further comprises a first cap thermoplastic polymer.

9. The method of claim 1, wherein the core thermoplastic polymer further comprises a flame retardant material.

10. The method of claim 1, wherein the first cap layer, upon heating and/or exposure to flames, forms a protective layer of greater than or equal to 1.5 centimeters.

11. The method of claim 1, wherein the first cap layer comprises a thickness of 50 micrometers to 1.5 millimeters.

12. The method of claim 1, wherein the core layer comprises a thickness of 4 millimeters to 55 millimeters.

13. The method of claim 12, wherein the core layer comprises a thickness of 0.5 millimeters to 20 millimeters.

14. The method of claim 1, further comprising an ablative coating layer.

15. The method of claim 1, wherein the core layer composition comprises polycarbonate.

16. The method of claim 1, wherein the first cap layer composition comprises a material selected from polyetherimide, polycarbonate, polysiloxane, polycarbonate-ester, polyethylene terephthalate, polyphenylene oxide, tetrabromobisphenol-A, and combinations comprising at least one of the foregoing.

17. The method of claim 16, wherein the first cap layer composition further comprises a flame retardant material selected from tetrabromobisphenol-A, potassium diphenyl sulfone-3-sulfonate, potassium perfluorobutane sulfonate, sodium p-toluene sulfonate, sodium trichlorobenzene sulfonate, and combinations comprising at least one of the foregoing.

18. The method of claim 1, further comprising a second cap layer, wherein the core layer is disposed between the first cap layer and the second cap layer or wherein the second cap layer is disposed between the first cap layer and the core layer.

19. A method of making an article, comprising:
co-extruding a core layer formed from a core composition comprising a core thermoplastic polymer and a first cap layer formed from a first cap composition comprising an intumescent flame retardant material to form a multilayer sheet; and
thermoforming the multilayer sheet to form the article, wherein the first cap layer and the core layer have an adhesion test value of greater than 2A as measured according to ASTM D3359-02 before thermoforming to form the article;
wherein, if a core layer and a cap layer formed from the same core composition and the same first cap composition are formed by another method to form another multilayer sheet, a thermoformed article of the another multilayer sheet will have an adhesion of less than 2A as measured according to ASTM D3359-02 before thermoforming to form another article.

20. A multilayer sheet, comprising:
an extruded first cap layer formed from a first cap composition comprising an intumescent flame retardant material; and
a co-extruded core layer formed from a core composition comprising a thermoplastic polymer, wherein the first cap layer is disposed upon and in intimate contact with a surface of the core layer;
wherein the first cap layer and the second cap layer have an adhesion test value of greater than 2 as measured according to ASTM D3359-02 before thermoforming the first cap layer and the second cap layer.

21. An article comprising the multilayer sheet of claim 20, wherein the article is thermoformed.
